(19) United States
(12) Patent Application Publication
(10) Pub. No.: US 2013/0020257 A1
(43) Pub. Date: Jan. 24, 2013

(54) Mainstream Wastewater Treatment

(71) Applicant: Donald McCarty, Elizabethtown, PA (US)

(72) Inventor: Donald McCarty, Elizabethtown, PA (US)

(73) Assignee: SEVERN TRENT WATER PURIFICATION, INC., Colmar, PA (US)

(21) Appl. No.: 13/636,600

(22) PCT Filed: Mar. 25, 2011
(86) PCT No.: PCT/US11/30029

§ 371 Date: Oct. 3, 2012

Related U.S. Application Data
(60) Provisional application No. 61/318,022, filed on Mar. 26, 2010.

(51) Int. Cl. C02F 3/02; C02F 3/30; C02F 101/16

(52) U.S. Cl. 210/614; 210/620; 210/630; 210/622; 210/150; 210/96.1

(57) ABSTRACT

One or more embodiments of the present invention relate to a short cut or shortened method for the removal of nitrogen from wastewater by pairing an aerobic fixed-film biological reactor with an anoxic fixed-film biological reactor under unique operating conditions.

### PRIORITY CLAIM

This application is a U.S. National stage entry under 35 U.S.C. 371 of PCT/US2011/030029 filed Mar. 25, 2011 and designating the United States which claims the benefit of earlier filing date and right to priority to U.S. Application No. 61/318,022 filed Mar. 26, 2010, the disclosure(s) of which is (are) expressly incorporated by reference herein.

### FIELD OF INVENTION

The present invention is in the field of wastewater treatment, specifically, nitrogen removal from wastewater. In particular, the invention is related to the removal of nitrogen from a wastewater treatment system.

### BACKGROUND

The presence of nitrogen compounds in lakes, rivers and other water resources has received worldwide attention. The presence of these nitrogen compounds in the environment is one of the primary causes of eutrophication. It is believed that these compounds promote unwanted growth of algae and other aquatic plants that consume dissolved oxygen. Consequently, there is increased demand to reduce nitrogen compounds in wastewater prior to its discharge. It has been observed that over the past few years, regulations for nitrogen removal by wastewater treatment plants have become more stringent.

### SUMMARY

One or more embodiments of the invention provide methods and systems for removing nitrogen from wastewater rich in ammonium-nitrogen.

One embodiment of the invention is a method for removing nitrogen from wastewater rich in ammonium-nitrogen. The method involves directing a mainstream of the wastewater to a first-stage reactor, the first-stage reactor comprising an aerobic treatment zone. The first-stage reactor may further comprise one or more anoxic treatment zones.

The method further involves operating a control system for short circuiting a conventional nitrification pathway in the first-stage reactor. The short circuiting facilitates partial oxidation of the ammonium-nitrogen in the mainstream to nitrites. An effluent comprising the nitrites from the partial oxidation in the first-stage reactor may be conveyed to a second-stage reactor for denitrification.

The second-stage reactor may be inoculated with heterotrophic denitrifying microorganisms. The method may further involve maintaining anoxic conditions in the second-stage reactor for facilitating reduction of the nitrites in the effluent to nitrogen gas. Denitrification occurring in the second-stage reactor may achieve total nitrogen levels substantially less than 5 mg/L. The denitrified effluent exiting the second-stage reactor may further comprise total phosphorous levels less than 0.3 mg/L.

The step of operating the control system may further involve creating an environment in the aerobic treatment zone that is conducive to short circuiting the conventional nitrification pathway by facilitating growth of ammonia oxidizing bacteria and inhibiting growth of nitrite oxidizing bacteria.

Moreover, operating the control system may involve controlling levels of dissolved oxygen in the mainstream to create the environment conducive to short circuiting. Controlling levels of dissolved oxygen in the mainstream may involve: receiving input values for one or more process parameters to generate at least one set point value for the one or more process parameters, the one or more process parameters affecting the short circuiting; calculating an initial factor corresponding to a percent of time for intermittently applying a fixed rate of process air to the first-stage reactor to create the conducive environment; sampling the mainstream to measure the one or more process parameters; and comparing the measured process parameters against the set point values and the calculated initial factor to regulate an intermittent application of the process air to the first-stage reactor. The one or more process parameters may comprise wastewater flow, ammonium, ammonium-nitrogen, ammonia, ammonia-nitrogen, nitrates, nitrate-nitrogen, nitrites, nitrite-nitrogen, chemical oxygen demand, biochemical oxygen demand, carbonaceous biochemical oxygen demand, dissolved oxygen, pH, alkalinity, geometry of the first-stage reactor, and geometry of the second-stage reactor. Controlling levels of dissolved oxygen in the mainstream may further involve introducing controlled amounts of dissolved oxygen to the first-stage reactor. Introducing controlled amounts of dissolved oxygen may be achieved by intermittently applying a fixed rate of process air to the first-stage reactor.

Operating the control system may further involve introducing controlled amounts of a carbon source to the second-stage reactor.

The method may further involve controlling pH levels in the first-stage reactor to about 8.3. The pH level control may further comprise introducing alkaline feedstock to the first-stage reactor and/or recycling a denitrified effluent from the second-stage reactor to the first-stage reactor.

Another embodiment of the invention is a system for removing nitrogen from wastewater rich in ammonium-nitrogen. The system may comprise a mainstream treatment system having a first-stage reactor, a second-stage reactor, and a control system.

The first-stage reactor may comprise an aerobic treatment zone. An environment in the aerobic treatment zone may be conducive to short circuiting the conventional nitrification pathway by facilitating growth of ammonia oxidizing bacteria and inhibiting growth of nitrite oxidizing bacteria. The first-stage reactor may further comprise one or more anoxic treatment zones.

The control system may facilitate a short circuiting of a conventional nitrification pathway in the first-stage reactor, the short-circuiting partially oxidizing ammonium nitrogen in the mainstream to nitrites.

An effluent comprising nitrites may be conveyed from the first-stage reactor to the second-stage reactor for denitrification. The second-stage reactor may be inoculated with heterotrophic denitrifying microorganisms and may comprise anoxic conditions for facilitating reduction of the nitrites in the effluent to nitrogen gas. The denitrification may achieve total nitrogen levels substantially less than 5 mg/L. The denitrified effluent exiting the second-stage reactor may further comprise total phosphorous levels less than 0.3 mg/L.

The control system may comprise a processor, one or more network interfaces for facilitating the short circuiting, and a computer memory operatively coupled to the processor. Computer program instructions for controlling levels of dissolved oxygen in the mainstream to create the environment conducive to short circuiting may be disposed within the computer memory and stored in a non-transitory storage medium. The control system may comprise a computer control system. The control system may further comprise a computer program stored on a non-transitory storage medium, the computer program including instructions configured to be executed on the computer control system to perform a method for controlling levels of dissolved oxygen in the mainstream to create the environment conducive to short circuiting, the controlling dissolved oxygen levels further comprising receiving input values for one or more process parameters to generate at least one set point value for the one or more process parameters, the one or more process parameters affecting the short circuiting; calculating an initial factor corresponding to a percent of time for intermittently applying a fixed rate of process air to the first-stage reactor to create the conducive environment; sampling the mainstream to measure the one or more process parameters; and comparing the measured process parameters against the set point values and the calculated initial factor to regulate an intermittent application of the process air to the first-stage reactor.

The one or more process parameters may comprise wastewater flow, ammonium, ammonium-nitrogen, ammonia, ammonia-nitrogen, nitrates, nitrate-nitrogen, nitrites, nitrite-nitrogen, chemical oxygen demand, biochemical oxygen demand, carbonaceous biochemical oxygen demand, dissolved oxygen, pH, alkalinity, geometry of the first-stage reactor, and geometry of the second-stage reactor.

The control system may further comprise means for introducing controlled amounts of dissolved oxygen to the first-stage reactor. The means for introducing controlled amounts of dissolved oxygen may comprise a process air blower.

The control system may further comprise means for introducing controlled amounts of a carbon source to the second-stage reactor.

These and other embodiments of the invention are described in detail with reference to the following drawings.

### BRIEF DESCRIPTION OF THE DRAWINGS

FIG. 1 shows an illustration of a conventional nitrification/denitrification process.

FIG. 2 shows an illustration of a conventional anammox short cut process.

FIG. 3 shows an illustration of a short cut nitrification/denitrification process in accordance with one or more embodiments of the invention.

FIG. 4 shows a flowchart illustrating a method in accordance with one or more embodiments of the invention.

FIG. 5 shows a system and process flow diagram for short cut nitrification/denitrification in accordance with one or more embodiments of the invention.

FIG. 6A shows a flowchart illustrating a method in accordance with one or more embodiments of the invention.

FIG. 6B shows a flowchart illustrating a method in accordance with one or more embodiments of the invention.

### DETAILED DESCRIPTION OF THE INVENTION

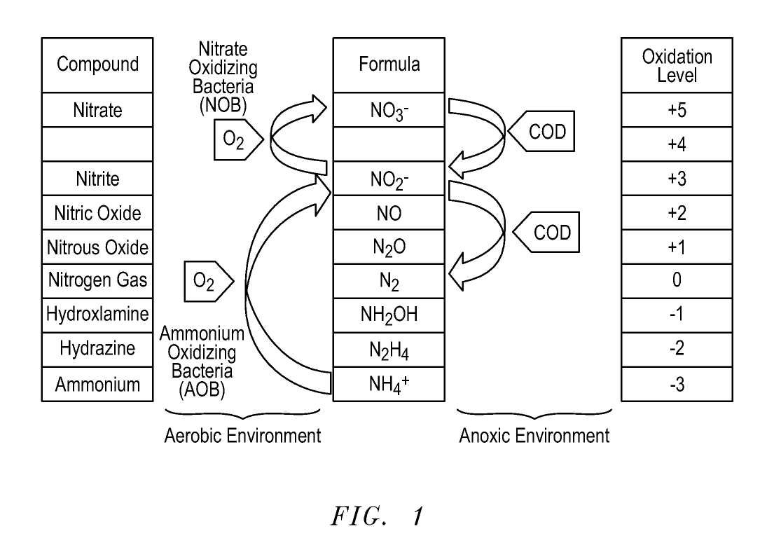

FIG. 1 represents a conventional process for removal of nitrogen from wastewater. As shown, this involves nitrification followed by denitrification. During nitrification, ammonia/nitrogen compounds in the wastewater are first oxidized into nitrites. This oxidation is performed by ammonia oxidizing bacteria (AOB) in the presence of dissolved oxygen. Ammonia oxidizing bacteria typically belong to the genus Nitrosomonas. The nitrite is then further oxidized into nitrate. This is primarily done by nitrite oxidizing bacteria (NOB) bacteria of the genus Nitrobacter. Nitrobacter is often found in tandem with Nitrosomonas since the end product of Nitrosomonas metabolism provides the energy substrate for Nitrobacter. Denitrification involves the reduction of the nitrate to nitrogen gas through a series of intermediate gaseous nitrogen oxide products. Denitrification is carried out in an anaerobic or anoxic environment, typically in the presence of bacteria requiring an external carbon source.

These conventional processes may involve high costs, primarily due to the aeration requirements, that is, bringing and introducing oxygen into the wastewater treatment plant for the nitrification reaction, and the addition of an external or supplemental carbon source (typically, methanol) for facilitation of the denitrification reaction. The supplemental carbon expense may represent as much as 80-90% of operating costs of denitrification. There is increasing pressure to reduce operating costs associated with supplemental carbon and process air requirements.

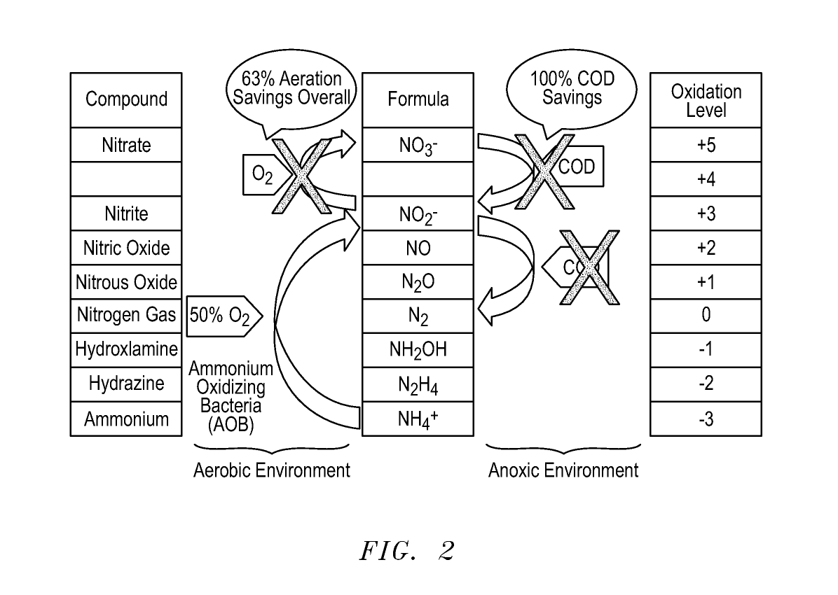

Processes have been developed to short-circuit the above-described nitrification/denitrification biological pathway via nitrite (NO2) which is a common intermediate product for both nitrification and denitrification. The terms “short-circuit” and “short cut” are used interchangeably herein. Referring to FIG. 2, these short-circuit processes involve initially producing an ammonium-nitrite mixture by converting the ammonium to nitrite in a single reactor using 50% of the oxygen for conventional processes. As seen in FIG. 2, this may result in a 63% overall reduction in dissolved oxygen requirements. The ammonium-nitrite mixture may be then converted under anoxic or anaerobic conditions to nitrogen gas with ammonium as the electron donor. The reaction relies on anammox, a slow-growing autotrophic bacteria, for catalyzing the reaction and facilitating the conversion to nitrogen. This process is carried out without addition of external or supplemental carbon sources.

These processes are sidestream recycle processes, that is, they are used to treat or process effluent/fluids obtained by dewatering of the sludge generated during the wastewater treatment cycle. Most of these processes use suspended growth systems, that is, they use microorganisms and bacteria suspended in the wastewater being treated. These processes are used to treat high-strength ammonium wastes (i.e., centrate from anaerobic digester sludge treatment), and they rely on anammox bacteria for the denitrification reaction. Moreover, these processes typically involve heat input and batch processing. Existing short-circuit processes typically achieve 80-90% nitrogen removal when applied to high-strength ammonium wastewater (typically about 1,000 mg/L ammonium-nitrogen). The resulting effluent still contains 100-200 mg/L nitrogen. Thus, further treatment, including discharging the treated effluent to the mainstream for additional nitrogen removal, may typically be required to achieve target nitrogen level reductions if the wastewater treatment plant is subject to stringent nitrogen discharge limits.

Although anammox bacteria is attractive because of its reduction or elimination of the need for supplemental carbon, it is notorious for long startup periods (approximately one year), toxicity issues, nitrite-limitation issues for single-stage applications, and effluent nitrate (NO3-N) production of about 10-12% of influent nitrogen. While these aspects might be manageable for a sidestream process, the same would not hold for mainstream processes subject to stringent nutrient effluent limits.

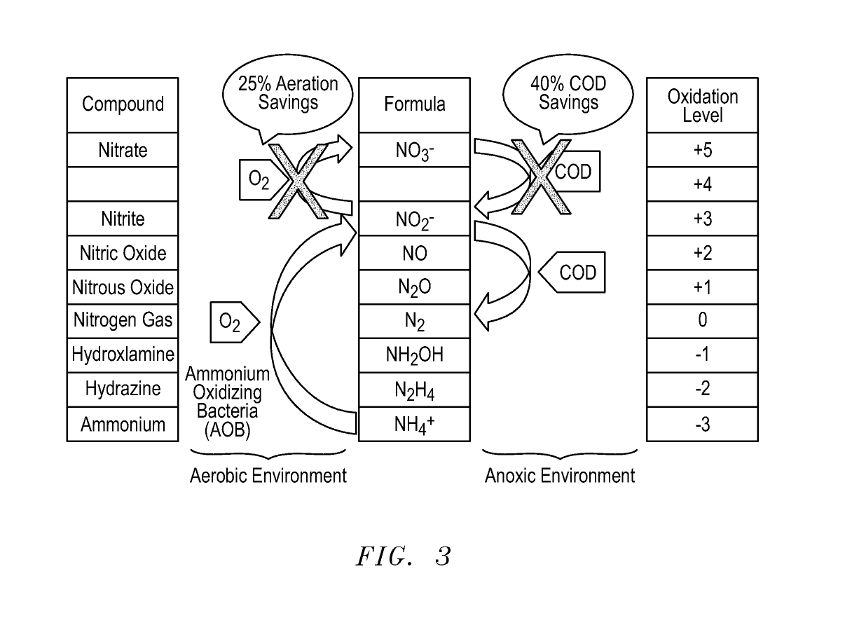

Referring now to FIG. 3, one or more embodiments of the present invention comprise methods and systems for the removal of nitrogen from wastewater by short-circuiting the nitrification pathway using the intermediary nitrite, which is common to both nitrification and denitrification reactions. In one or more embodiments of the invention, at least one aerobic biofilter is paired with at least one anoxic biofilter under unique operating conditions. Exemplary processes and apparatus for nitrification and denitrification have been disclosed in U.S. Pat. Nos. 5,776,344 to McCarty et al. and in 7,396,466 to Bonazza et al. The contents of these referenced patents are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

The methods of the invention may involve treatment of mainstream, as opposed to sidestream, wastewater treatment. One or more embodiments of the invention may result in lower energy requirements and supplemental carbon needs compared to those for conventional nitrification/denitrification.

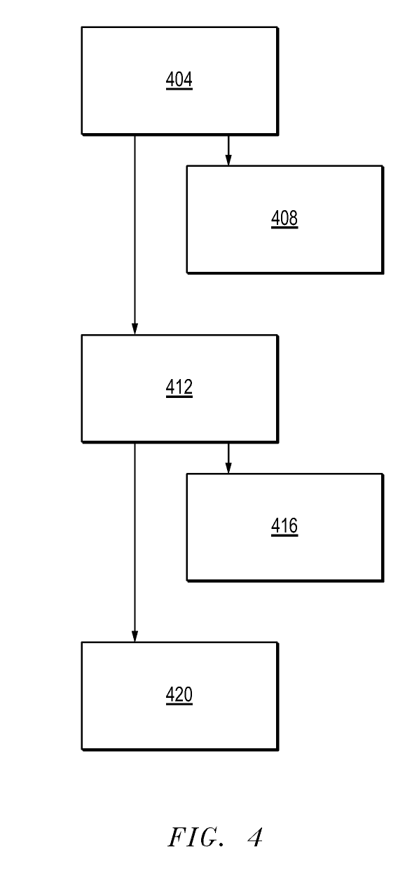

Referring now to FIG. 4, in one or more embodiments of the invention, the wastewater may be initially passed through an aerobic biofilter used as a first-stage reactor 404. The first-stage reactor may be under aerobic and controlled operating conditions. The first-stage aerobic reactor comprises granular media and a biological fixed-film or biofilm on the media. AOB may be active on the outer layers of the biofilm. This outer layer may be in direct contact with the wastewater comprising dissolved oxygen. This promotes conversion of ammonia and nitrogen compounds in the wastewater to nitrites 408. The first-stage reactor may accomplish partial nitrification (nitritation) and simultaneous nitrification/denitrification (SND) at low dissolved oxygen conditions. The effluent comprising the nitrites is then conveyed to an anoxic biofilter used as a second-stage reactor 412. The second-stage reactor may be under anoxic conditions. The second-stage reactor comprises granular media and a biological fixed-film or biofilm on the media. The biofilm on the second-stage reactor is inoculated with heterotrophic bacteria. Heterotrophic bacteria reduce the nitrites to gaseous nitrogen 416, including elemental nitrogen, which may then be purged or expelled from the wastewater 420.

The embodiments of the system of the invention occupy a smaller footprint as compared to conventional nitrification/denitrification systems, making it applicable for sites with limited space, and especially those that must retrofit to meet more stringent nitrogen discharge limits.

The embodiments of the invention utilize a fixed-film approach unlike the suspended growth systems of the conventional short cut processes. In fixed film systems, the nitrifying and denitrifying bacteria and other microorganisms exist and grow on a fixed support structure. The fixed film processes are inherently stable and resistant to organic and hydraulic shock loadings.

The denitrification reaction may be carried out by proven heterotrophic bacteria, as opposed to denitrification using autotrophic anammox bacteria as used in conventional short cut processes. Heterotrophic bacteria require an external organic carbon source to obtain their energy and nutrition. In direct contrast, an autotroph is an organism able to make its own food. Autotrophic organisms take inorganic substances into their bodies and transform them into organic matter. However, autotrophs, such as anammox bacteria, have long start-ups, slow recovery after upset, and often require supplemental heat to compensate for slow growth. As used herein, the term “anoxic” means the absence of free dissolved oxygen, in contrast with “anaerobic” which means the absence of oxygen including chemically bound oxygen.

One or more embodiments of the present invention may result in significant reductions in the required oxygen to be transferred for oxidation and also in the amount of carbon addition required for bacterial growth in denitrification. Since the oxidation of ammonia is only taken to nitrite, and nitrite is reduced instead of being taken to nitrate and then having the nitrate reduced, there may be a 25% reduction in oxygen requirements and a 40% reduction in carbon requirements.

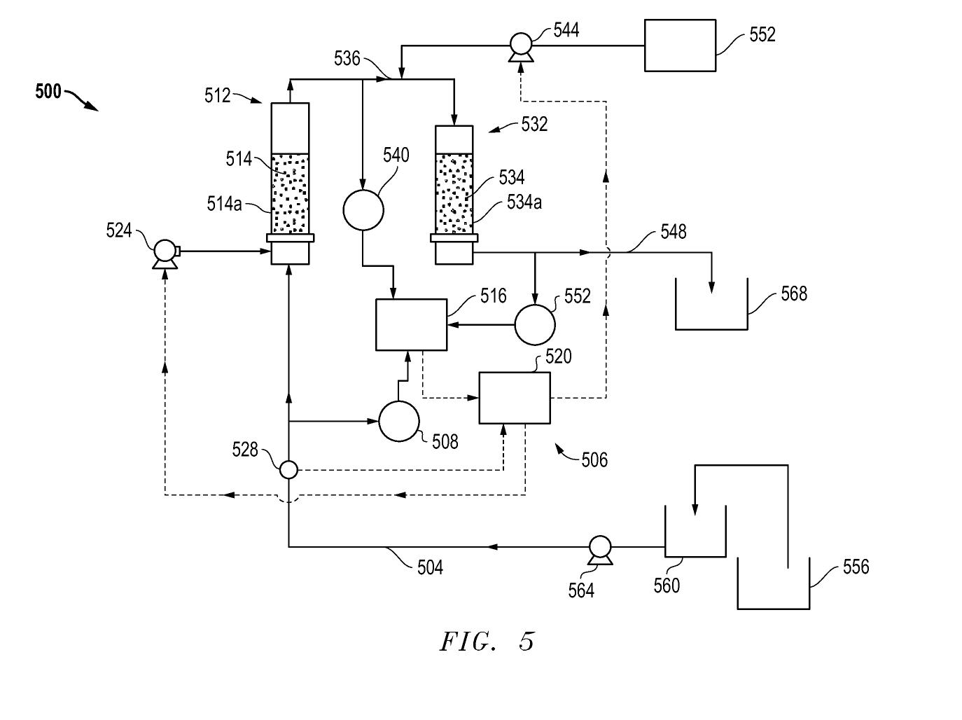

FIG. 5 depicts a system and process flow diagram for carrying out a method in accordance with one or more embodiments of the invention. The system 500 comprises a first-stage aerobic reactor 512 and a second-stage anoxic reactor 532. The first-stage aerobic reactor 512 and the second-stage anoxic reactor 532 may include a biologically active material (not shown). The biologically active material broadly includes any microorganism affixed to a solid support (not shown) that is capable of accomplishing the desired nitrification or denitrification. The material may be in the form of a fixed film, which is herein defined as microorganisms that grow in a film on a support structure. In the one or more embodiments of the invention, the support structure may comprise granular media 514, 534 packed in one or more substantially horizontal layers 514a, 534a. As shown in FIG. 5, the first-stage reactor 512 and the second-stage reactor 532 each may comprise a single monomedia. However, multiple layers may be used in other embodiments. Multiple layers in a single reactor may be stacked vertically. Different layers may comprise different types and/or sizes of support structures. The support structure may include granular media 514, 534 such as silica sand, a plastic media such as plastic beads, one or more sheets (not shown) such as plastic sheets, or some other support such as rotating biological contactors (not shown). The biologically active material may comprise a biologically active filter or biofilter. For example, the filter may include granular media 514, 534 configured in a packed bed reactor 512, 532 and inoculated with microorganisms, having a porosity of less than about 80%. In other embodiments, the porosity may be less than about 60%. In yet other embodiments, the porosity may be less than about 40%. The aerobic biofilter 512 may be inoculated with the nitrifying bacteria, such as AOB, while the anoxic biofilter 532 may be inoculated with heterotrophic bacteria.

The AOB may be grown on the support by passing wastewater through the biologically active material and controlling conditions under which AOB may grow while creating conditions necessary to reduce or eliminate the NOB. Growth of AOB may be affected by many factors, including, but not limited to, dissolved oxygen, pH, alkalinity, nitrogen loading, BOD loading, trace nutrients, temperature, reaction time, and hydraulic shear related to hydraulic loading of the first-stage reactor.

As described earlier, the first-stage aerobic reactor 512 comprises a biofilm. While AOB is active on the outer layers of this biofilm because it is in contact with oxygen-rich wastewater, the deeper layers of the biofilm may have limited to non-existent access to dissolved oxygen. These conditions promote growth of anammox and heterotrophic bacteria. These denitrifying bacteria may further affect some level of nitrogen removal depending on diffusion and wastewater characteristics. As mentioned earlier, the amount of dissolved oxygen provided to the first-stage aerobic reactor 512 may also be limited or controlled. This also promotes the growth of anammox or heterotrophic bacteria in the deeper layers of the biofilm. The denitrifying bacteria may convert some of the nitrite produced in the outer layers of the biofilm to nitrogen gas. While this denitrification may constitute a bonus or an added advantage, target denitrification levels may be achieved by conveying an effluent 536 comprising nitrites from the first-stage aerobic reactor 512 to the second-stage anoxic reactor 532. In the second-stage anoxic reactor 532, heterotrophic bacteria promote denitrification in a proven and controllable manner.

In yet another embodiment, both nitrification and denitrification may be carried out in a single reactor 512 having process air (dissolved oxygen) applied at a location within the granular media 514. This may affect both an outer aerobic layer and an inner anoxic layer. Such a reaction may be carried out in an upflow mode with the effluent being recycled for optimal nitrogen removal.

In the second-stage reactor 532, anoxic or similar conditions may be maintained to facilitate reduction of the nitrites to nitrogen. In the one or more embodiments of the invention, denitrification may be carried out using a deep bed fixed-film biological denitrification reactor to provide total nitrogen (TN) and total phosphorous (TP) removal. The denitrification reactor 532 may be used as the final treatment step in the TN and TP removal processes to help a wastewater treatment facility meet stringent TN and TP effluent limits. Effluent limits for TN and TP may be less than 1-10 mg/L and less than 0.1-2 mg/L, respectively. In one or more embodiments, effluent limits for TN and TP may be less than 5 mg/L and less than 0.3 mg/L, respectively These effluent limits are substantially lower than the quality of effluent from sidestream processes (e.g., 100-200 mg/L TN), for which existing short-circuit processes are designed.

Specially sized and shaped granular media 534 may be used in the second-stage reactor 532. The media functions as a support medium for denitrifying heterotrophic bacteria and the deep bed environment is conducive to efficient reduction of nitrite to nitrogen gas and solids removal. The contact between wastewater and biomass is facilitated and hydraulic short-circuiting is negligible even during plant upsets.

The media within the first-stage reactor 512 and/or the second-stage reactor 532 may further allow for heavy capture of solids of at least 1.0 pound of solids per square foot of filter surface area before backwashing may be required.

Conventional heterotrophic bacteria may exist as a fixed-film on the second-stage anoxic reactor 532. The heterotrophic bacteria convert the nitrites to nitrogen gas in the presence of an external carbon source, which may be stored in a carbon source tank 552. The carbon source feeds the heterotrophic microorganisms or bacteria. Examples of carbon sources capable of working with microorganisms within the filter unit for denitrification are methanol, ethanol, glycerine, acetic acid, brewery wastes, sugars, primary effluent, and combinations of these. The carbon source may be introduced in a controlled manner using automated means. The automated means may also be used simultaneously for auto dosing of metal salts for ortho phosphate removal.

The second-stage denitrification reactor 532 may employ a “bump” operation to remove or purge accumulated gas—nitrogen or CO₂—that can build up in the biofilter media 534. If desired, this bumping can be accomplished without removing the second-stage reactor 532 from service by applying backwash water to the bottom of the biofilter, releasing the entrapped gas into the atmosphere and reducing headloss.

Since the one or more embodiments of the invention comprise mainstream wastewater treatment, tighter control on nitrogen and phosphorous levels in the effluent may be required. Effluent limits of less than 5 mg/L TN and less than 0.3 mg/L TP may be achieved by embodiments of the methods and systems of the present invention. This is in contrast to existing short-circuit processes, which typically achieve 80-90% nitrogen removal when applied to high-strength ammonium wastewater (typically about 1,000 mg/L ammonium-nitrogen), resulting in an effluent that still contains 100-200 mg/L nitrogen. Thus, the existing short-circuit processes may require further treatment, including discharging the treated effluent to the mainstream for additional nitrogen removal, to achieve target nitrogen level reductions if the wastewater treatment plant is subject to stringent nitrogen discharge limits.

One or more embodiments of the invention involve controlling one or more process parameters during the passage of the wastewater through the first-stage fixed-film biological reactor 512 in order to create an environment conducive to the growth of ammonia oxidizing bacteria (AOB) while inhibiting the growth of nitrite oxidizing bacteria (NOB). Thus, optimal conditions would maximize AOB while substantially reducing or eliminating NOB.

In accordance with one or more embodiments of the invention, NOB may be inhibited by controlling the concentration of dissolved oxygen within the first-stage reactor 512. The dissolved oxygen concentration may be controlled “indirectly,” i.e., by measuring process parameters other than dissolved oxygen concentration, and using the measured process parameters as feedback in a control system.

The system 500 may further comprise a wastewater source 556, a feed tank 560, a feed pump 564, an influent mainstream of wastewater 504, a clearwell 568, and a control system 506. The control system 506 further comprises a flow meter 528, an influent sampler 508, an intermediate sampler 540, an effluent sampler 552, an analyzer 516, the process air blower 524, a carbon feed pump 544, and a controller 520.

Wastewater from a wastewater source 556 may be supplied to the feed tank 560. To transport the wastewater from the wastewater source 556 to the feed tank 560, a sump pump (not shown), a pumping station (not shown), or flow by gravity (not shown), among other things, may be used in one or more embodiments. The feed pump 564 may pump the wastewater in the feed tank 560 as the mainstream of influent wastewater 504 to the first-stage reactor 512. The mainstream of influent wastewater 504 may contain nitrogen compounds, such as ammonium-nitrogen (NH4-N). Samples of the influent wastewater 504 may be collected by the influent sampler 508 prior to the influent wastewater 504 entering the first-stage nitrification reactor 512. The influent sampler 508 may be in communication with the analyzer 516. The analyzer 516 may be used to determine various process parameters, such as concentrations of ammonium (NH4), ammonium-nitrogen (NH4-N), ammonia (NH3), ammonia-nitrogen (NH3-N), nitrates (NO3), nitrate-nitrogen (NO3-N), nitrites (NO2), and nitrite-nitrogen (NO2-N), in the influent wastewater 504 based on the sample collected by the influent sampler 508. In one or more embodiments, the analyzer 516 may comprise an instrument that can detect chemical substances that absorb light in the ultraviolet or visible wavelength range.

The flow meter 528 may be disposed along the flow path of mainstream influent wastewater stream 504, upstream from the first-stage reactor 512. The flow meter 528 may be used to measure the flow rate of the influent wastewater 504.

The controller 520 may comprise a programmable logic controller (PLC) (not shown) and a human-machine interface (HMI) (not shown). The HMI may allow an operator to enter one or more predetermined set point values of one or more process parameters that the PLC may control using computer program instructions. The controller 520 may further comprise a processor (not shown); one or more network interfaces (not shown); and a computer memory (not shown). The computer memory may have disposed within it computer program instructions (not shown) for controlling levels of dissolved oxygen in the mainstream to create conditions conducive to short circuiting a conventional nitrification pathway in the first-stage reactor 512, including, but not limited to: computer program instructions for receiving input values for one or more process parameters to generate at least one set point value for the one or more process parameters; computer program instructions for calculating an initial factor corresponding to a percent of time for intermittently applying a fixed rate of process air to the first-stage reactor 512; computer program instructions for accepting measurements of the one or more process parameters received from sampling the mainstream; and computer program instructions for comparing the measured process parameters against the set point values and the calculated initial factor to regulate an intermittent application of process air to the first-stage reactor 512.

The controller 520 may receive one or more input values and determine an initial percent aeration factor (PAF), i.e., an initial factor corresponding to a percent of time that a fixed rate of process air is to be intermittently applied to the first-stage reactor 512. The factor may be used to achieve optimal AOB growth promotion and NOB growth inhibition based on computer program instructions. A minimum fixed rate of process air to be applied to the first-stage reactor 512 of substantially at least 0.8 icfm/sf may be required to ensure even distribution of the process air within the first-stage reactor 512.

Process parameters on which a factor determination may be based include wastewater flow, ammonium (NH4), ammonium-nitrogen (NH4-N), ammonia (NH3), ammonia-nitrogen (NH3-N), nitrates (NO3), nitrate-nitrogen (NO3-N), nitrites (NO2), and nitrite-nitrogen (NO2-N), chemical oxygen demand (COD), biochemical oxygen demand (BOD), carbonaceous biochemical oxygen demand (cBOD), dissolved oxygen, pH, alkalinity, geometry of the first-stage reactor 512, and geometry of the second-stage reactor 532. The foregoing list of process parameters is not exhaustive. Any process parameter suitable for determining a factor that will achieve optimal AOB growth promotion and NOB growth inhibition may be used.

The controller 520 may regulate a process air blower 524 based on the factor determination. The process air blower 524 may intermittently supply dissolved oxygen into the first-stage reactor 512 such that conditions are created to optimize the growth of AOB and inhibit the growth of NOB within the first-stage reactor 512, which short cuts nitrification/denitrification as described previously with reference to FIG. 3. For example, a calculated factor of 50% may be implemented as 30 minutes of aeration in an hour followed by 30 minutes of no aeration, or 15 minutes of aeration in a 30 minute period followed by 15 minutes of no aeration. A unit period of time may be defined, and the factor may be applied to the unit period to control the frequency and duration of operation of the process air blower 524.

The analyzer 516 and the flow meter 528 may be in communication with and provide input values (corresponding to process parameters) to the controller 520.

Upon receiving the collected sample of influent wastewater 504 from the influent sampler 508, the analyzer 516 may analyze the influent wastewater 504 sample to determine its NH4-N concentration. The analyzer 516 may then relay the determined NH4-N concentration to the controller 520. In one or more embodiments of the invention, the controller 520 may determine an initial factor based on the NH4-N concentration and the measured flow rate of the mainstream influent wastewater 504.

The influent wastewater 504 may flow through the first-stage reactor 512 where the AOB oxidizes the nitrogen compounds, such as ammonium, to nitrites. In one or more embodiments of the invention, the influent wastewater 504 may flow through the first-stage reactor 512 in an upward direction (upflow). However, the influent wastewater 504 may flow through the first-stage reactor 512 in a downward direction (downflow) in other embodiments. The substantial or complete absence of NOB prevents the further oxidation of nitrites to nitrates. A stream of first-stage reactor effluent 536 may flow from the first-stage reactor 512 to a second-stage denitrification reactor 532, the second-stage reactor disposed downstream from the first-stage reactor 512.

An intermediate sampler 540 may collect samples of the stream of first-stage reactor effluent 536 prior to the stream 536 entering the second-stage reactor 532. The intermediate sampler 540 may be in communication with the analyzer 516. The analyzer 516 may be used to determine the concentrations of various process parameters, such as NH4-N, NO3-N, and NO2-N, in the influent wastewater 504 based on the sample collected by the intermediate sampler 540. The analyzer 516 communicates this information to the controller 520, which in turn uses the determined concentration of each of NH4-N, NO3-N and NO2-N as input values for adjusting its factor determination. For example, a predetermined set point value may be a concentration of NH4-N of approximately 1 mg/L. If the NH4-N concentration of the sample collected by the intermediate sampler 540 is greater than this set point value of approximately 1 mg/L NH4-N concentration, then the factor may be adjusted upward (a higher percentage) as the NH4-N concentration indicates that not enough process air is being applied within the first-stage reactor 512, i.e., not enough of the wastewater ammonium is being oxidized. Similarly, a predetermined set point value may be a concentration of NO3-N of approximately 1 mg/L. If the NO3-N concentration of the sample collected by the intermediate sampler 540 is greater than this set point value of approximately 1 mg/L NO3-N concentration, then the factor may be adjusted downward (a lower percentage) as the NO3-N concentration indicates that too much process air is being applied within the first stage reactor 512, i.e., the abundance of process air is creating conditions in which NOB growth is not being sufficiently inhibited and thus nitrites are being oxidized to nitrates. Other process parameters, such as dissolved oxygen concentration and pH may also be measured and factored into the factor calculation as tertiary levels of control.

As the stream of first-stage reactor effluent 536 flows through the second-stage reactor 532, the heterotrophic bacteria reduce the nitrites in the stream 536 to nitrogen gas. The nitrogen gas may be purged or expelled from the stream 536. An effluent stream 548 exits the second-stage reactor and into the clearwell 568. The effluent stream 548 stored in the clearwell 568 may undergo further treatment.

An effluent sampler 552 may collect samples of the effluent stream 548. The effluent sampler 552 may be in communication with the analyzer 516. The analyzer 516 may be used to determine the concentrations of various process parameters, such as NH4-N, NO3-N, and NO2-N, in the effluent stream 548 based on the sample collected by the effluent sampler 552. The analyzer 516 communicates this information to the controller 520, which in turn uses the determined concentration of each of NH4-N, NO3-N and NO2-N as input values for further adjusting its factor determination. The controller 520 may also use these process parameters to regulate a carbon feed pump 544 that supplies a carbon source from the carbon source tank 552 to the second-stage reactor 532. The heterotrophic microorganisms or bacteria use the carbon as its energy source for growth.

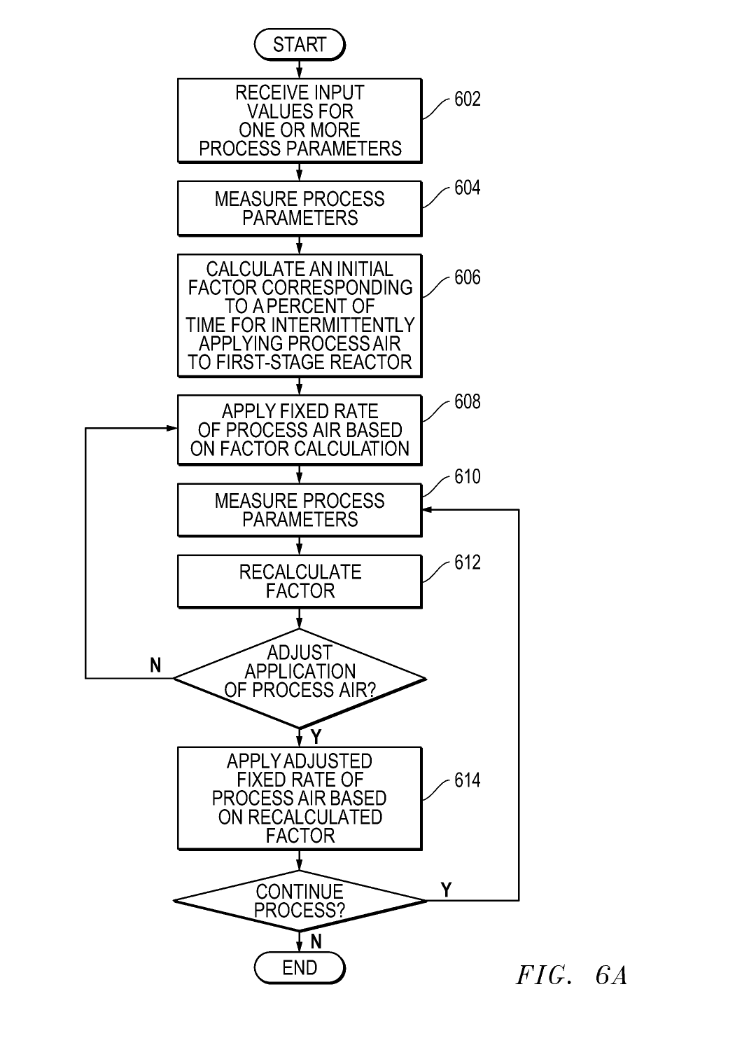

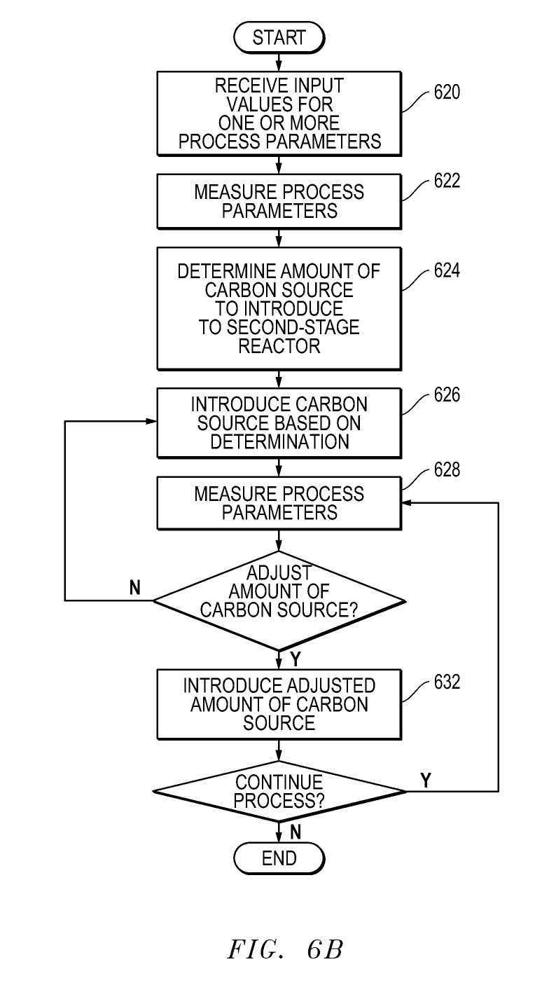

FIG. 6A shows a flow chart illustrating a method of operating a control system to control levels of dissolved oxygen in the mainstream in accordance with one or more embodiments of the invention. Controlling levels of dissolved oxygen in the mainstream creates an environment conducive to short circuiting a conventional nitrification pathway in the first-stage reactor.

The method of operating the control system may involve receiving input values for one or more process parameters 602. These input values may be entered into the control system by an operator using a human-machine interface (HMI) and received by a programmable logic controller (PLC) in communication with the HMI.

One or more process parameters may be measured 604 in order to calculate an initial factor corresponding to a percent of time for intermittently applying a fixed rate of process air to the first-stage reactor 606. A fixed rate of process air may be applied to the reactor based on the calculated factor 608 in order to create the environment conducive to short circuiting a conventional nitrification pathway in the first-stage reactor (i.e., facilitate growth of ammonia oxidizing bacteria and inhibiting growth of nitrite oxidizing bacteria).

The process parameters may be measured periodically 610 in order to recalculate the aforementioned factor 612 that corresponds to a percent of time for intermittently applying a fixed rate of process air to the first-stage reactor. Alternatively, one or more of the process parameters may be continually measured rather than periodically measured. The recalculated factor 612 may be different than the initially calculated factor 606. If so, an adjusted fixed rate of process air may be applied 614. An increase in the recalculated factor 612 relative to the initially calculated factor 606 may correspond with an increase in the percent of time for intermittently applying a fixed rate of process air to the first-stage reactor. A decrease in the recalculated factor 612 relative to the initially calculated factor 606 may correspond with a decrease in the percent of time for intermittently applying a fixed rate of process air to the first-stage reactor.

In this manner, the control system may employ a feedback loop, measuring process parameters 610 and adjusting the percent of time for intermittently applying a fixed rate of process air to the first-stage reactor 614. This allows for controlling levels of dissolved oxygen in the mainstream, which creates an environment conducive to short circuiting a conventional nitrification pathway in the first-stage reactor (i.e., facilitate growth of ammonia oxidizing bacteria and inhibiting growth of nitrite oxidizing bacteria).

FIG. 6B shows a flow chart illustrating a method of operating a control system to control levels of a carbon source in the second-stage reactor.

The method of operating the control system may involve receiving input values for one or more process parameters 620. These input values may be entered into the control system by an operator using a human-machine interface (HMI) and received by a programmable logic controller (PLC) in communication with the HMI.

One or more process parameters may be measured 622 in order to determine an amount of a carbon source to introduce to the second-stage reactor 624. An amount of carbon may be introduced to the second-stage reactor 626 based on the determination 624.

The process parameters may be measured periodically 628 in order to determine whether the amount of carbon source introduced to the second-stage reactor should be adjusted 632. Alternatively, one or more of the process parameters may be continually measured rather than periodically measured.

In this manner, the control system may employ a feedback loop, measuring process parameters 628 and adjusting the amount of carbon introduced to the second-stage reactor 632. This allows for controlling levels of a carbon source in the second-stage reactor.

Referring back to FIG. 5, in accordance with one or more embodiments of the invention, NOB is inhibited by adjusting the pH of the influent wastewater 504 within the first-stage reactor 512. The AOB existing on the outer layers of the biofilm act on the ammonia/nitrogen compounds to oxidize these compounds to nitrites. In one embodiment of the invention, the pH of the first-stage aerobic reactor 512 is maintained at about 8.3. Growth rate of nitrite NOB, responsible for converting nitrites to nitrates, may be eight times higher at a pH of 7 compared to at a pH of about 8. However, the growth rate of the AOB may change negligibly in this pH range. Operating at a pH of about 8.3 may favor the desired AOB and inhibit the undesirable NOB, thereby promoting conversion of ammonia to nitrite, while suppressing oxidation of nitrite to nitrate. The higher pH may further affect the available form of ammonium/ammonia, creating more available in the ammonia (NH3) form, which may also inhibit the growth of NOB. Other process parameters that may be controlled to create an environment conducive to substantially reducing or eliminating NOB include, but are not limited to, oxidation-reduction potential (ORP), Oxygen Uptake Rate (OUR), ammonium-nitrogen (NH4-N), free ammonia (FA), free nitrous acid (FNA), temperature, salinity, and sludge age.

Feedstock comprising sodium bicarbonate, sodium hydroxide, or magnesium hydroxide may be used to adjust the pH or to add alkalinity. However, any chemical compound suitable for adjusting the pH or adding alkalinity may be used. In yet another embodiment, the effluent from the second-stage anoxic/denitrification reactor 532 may be recycled for further nitrogen removal and to balance alkalinity in the system. The alkalinity may also assist in controlling the pH to about 8.3.

The use of a fixed-film biofilm reactor instead of a suspended-growth system may also inhibit NOB. AOB may exist on the outer parts of the biofilm while NOB may exist deeper within the biofilm where oxygen is limited. The half saturation constant, Ks, is 0.3 mg/L for AOB and 1.1 mg/L for NOB, which may further work to inhibit NOB (lower saturation constants show more affinity for oxygen).

Although not illustrated in FIG. 5, it is to be understood that various combinations of effluent recycling may be done to further effectuate nitrification/denitrification in accordance with one or more embodiments of the invention. For example, the first-stage reactor effluent 536 and/or the second-stage effluent stream 548 may be recycled back through the first-stage reactor 512. Another recycle process may involve recycling the second-stage effluent stream 548 back through the second stage reactor 532. Chemical addition to adjust pH and supplement alkalinity is also not illustrated in FIG. 5. Furthermore, one or more embodiments of the invention may comprise multiple first-stage nitrification reactors 512 and/or second-stage nitrification reactors 532 in series or in parallel or a combination thereof.

Exemplary methods and systems for removing nitrogen from wastewater rich in ammonium-nitrogen according to embodiments of the present invention are described with reference to the accompanying drawings. The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, components, acts, and equivalents of all means or step plus function elements in the claims below are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application, and to enable others of ordinary skill in the art to understand the invention for various embodiments with various modifications as are suited to the particular use contemplated.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a non-transitory computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

Aspects of the present invention are described below with reference to flowchart illustrations and/or block diagrams of methods, apparatus (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It is to be understood that the invention is not to be limited or restricted to the specific examples or embodiments described herein, which are intended to assist a person skilled in the art in practicing the invention. Although the invention is preferably directed to the removal of nitrogen compounds from wastewater, it is not necessarily limited to such applications. For example, the invention may also be used to reduce phosphorus contaminants or BOD pollutants in wastewater. The invention may also be applied to large scale treatment facilities or industrial applications. Accordingly, numerous changes may be made to the details of procedures for accomplishing the desired results. These and other similar modifications will readily suggest themselves to those skilled in the art, and are intended to be encompassed within the spirit of the present invention disclosed herein and the scope of the appended claims.

1. A method for removing nitrogen from wastewater rich in ammonium-nitrogen comprising:
directing a mainstream of the wastewater to a first-stage reactor, the first-stage reactor comprising an aerobic treatment zone;
operating a control system for short circuiting a conventional nitrification pathway in the first-stage reactor, the short circuiting facilitating partial oxidation of the ammonium-nitrogen in the mainstream to nitrites; and
denitrifying the nitrites by conveying an effluent comprising the nitrites from the first-stage reactor to a second-stage reactor, the second-stage reactor inoculated with heterotrophic denitrifying microorganisms,
the denitrification achieving total nitrogen levels substantially less than 5 mg/L.

2. The method of claim 1, the first-stage reactor further comprising one or more anoxic treatment zones.

3. The method of claim 2, the operating the control system further comprising creating an environment in the aerobic treatment zone that is conducive to short circuiting the conventional nitrification pathway by facilitating growth of ammonia oxidizing bacteria and inhibiting growth of nitrite oxidizing bacteria.

4. The method of claim 3, the operating the control system further comprising:
controlling levels of dissolved oxygen in the mainstream to create the environment conducive to short circuiting, the controlling dissolved oxygen levels further comprising:
receiving input values for one or more process parameters to generate at least one set point value for the one or more process parameters, the one or more process parameters affecting the short circuiting;
calculating an initial factor corresponding to a percent of time for intermittently applying a fixed rate of process air to the first-stage reactor to create the conducive environment;
sampling the mainstream to measure the one or more process parameters; and
comparing the measured process parameters against the set point values and the calculated initial factor to regulate an intermittent application of the process air to the first-stage reactor.

5. The method of claim 4, the controlling dissolved oxygen levels further comprising introducing controlled amounts of dissolved oxygen to the first-stage reactor.

6. The method of claim 5, the introducing controlled amounts of dissolved oxygen to the first-stage reactor further comprising intermittently applying a fixed rate of process air to the first-stage reactor.

7. The method of claim 5, the operating the control system further comprising introducing controlled amounts of a carbon source to the second-stage reactor.

8. The method of claim 4, the one or more process parameters further comprising wastewater flow, ammonium, ammonium-nitrogen, ammonia, ammonia-nitrogen, nitrates, nitrate-nitrogen, nitrites, nitrite-nitrogen, chemical oxygen demand, biochemical oxygen demand, carbonaceous biochemical oxygen demand, dissolved oxygen, pH, alkalinity, geometry of the first-stage reactor, and geometry of the second-stage reactor.

9. The method of claim 1, further comprising controlling pH levels in the first-stage reactor to about 8.3, the pH level control further comprising:
introducing alkaline feedstock to the first-stage reactor and/or recycling a denitrified effluent from the second-stage reactor to the first-stage reactor.

10. The method of claim 1, further comprising maintaining anoxic conditions in the second-stage reactor for facilitating reduction of the nitrites in the effluent to nitrogen gas.

11. The method of claim 1, the denitrified effluent exiting the second-stage reactor comprising total phosphorous levels less than 0.3 mg/L.

12. A system for removing nitrogen from wastewater rich in ammonium-nitrogen comprising:
a mainstream treatment system comprising:
a first-stage reactor, the first-stage reactor comprising an aerobic treatment zone;
a control system, the control system facilitating a short circuiting of a conventional nitrification pathway in the first-stage reactor, the short circuiting partially oxidizing ammonium-nitrogen in the mainstream to nitrites; and
a second-stage reactor, wherein an effluent comprising nitrites is conveyed from the first-stage reactor to the second-stage reactor for denitrification, the second-stage reactor inoculated with heterotrophic denitrifying microorganisms,
the denitrification achieving total nitrogen levels substantially less than 5 mg/L.

13. The system of claim 12, the first-stage reactor further comprising one or more anoxic treatment zones.

14. The system of claim 13, the first-stage reactor further comprising an environment in the aerobic treatment zone that is conducive to short circuiting the conventional nitrification pathway by facilitating growth of ammonia oxidizing bacteria and inhibiting growth of nitrite oxidizing bacteria.

15. The system of claim 14, the control system comprising a computer control system, the control system further comprising:
a computer program stored on a non-transitory storage medium, the computer program including instructions configured to be executed on the computer control system to perform a method for controlling levels of dissolved oxygen in the mainstream to create the environment conducive to short circuiting, the controlling dissolved oxygen levels further comprising:
receiving input values for one or more process parameters to generate at least one set point value for the one or more process parameters, the one or more process parameters affecting the short circuiting;
calculating an initial factor corresponding to a percent of time for intermittently applying a fixed rate of process air to the first-stage reactor to create the conducive environment;
sampling the mainstream to measure the one or more process parameters; and
comparing the measured process parameters against the set point values and the calculated initial factor to regulate an intermittent application of the process air to the first-stage reactor.

16. The system of claim 15, the control system further comprising means for introducing controlled amounts of dissolved oxygen to the first-stage reactor.

17. The system of claim 16, the control system further comprising means for introducing controlled amounts of a carbon source to the second-stage reactor.

18. The system of claim 15, the one or more process parameters further comprising wastewater flow, ammonium, ammonium-nitrogen, ammonia, ammonia-nitrogen, nitrates, nitrate-nitrogen, nitrites, nitrite-nitrogen, chemical oxygen demand, biochemical oxygen demand, carbonaceous biochemical oxygen demand, dissolved oxygen, pH, alkalinity, geometry of the first-stage reactor, and geometry of the second-stage reactor.

19. The system of claim 16, the means for introducing controlled amounts of dissolved oxygen comprising a process air blower.

20. The system of claim 12, the second-stage reactor further comprising anoxic conditions for facilitating reduction of the nitrites in the effluent to nitrogen gas.

21. The system of claim 12, the denitrified effluent exiting the second-stage reactor comprising total phosphorous levels less than 0.3 mg/L.
